(19) United States
(12) Patent Application Publication
(10) Pub. No.: US 2026/0023421 A1
(43) Pub. Date: Jan. 22, 2026

(54) ELECTRONIC APPARATUS AND PERFORMANCE CONTROL METHOD THEREOF

(71) Applicant: COMPAL ELECTRONICS, INC., Taipei City (TW)

(72) Inventors: Chin-Chia Chang, Taipei City (TW); Hsiao-Wen Tseng, Taipei City (TW)

(73) Assignee: COMPAL ELECTRONICS, INC., Taipei City (TW)

(21) Appl. No.: 19/269,071

(22) Filed: Jul. 15, 2025

Related U.S. Application Data
(60) Provisional application No. 63/671,768, filed on Jul. 16, 2024.

(51) Int. Cl. G06F 1/26; G06F 9/4401

(52) U.S. Cl. CPC G06F 1/26; G06F 9/4401

(57) ABSTRACT

An electronic apparatus and a performance control method thereof are provided. The following steps are executed through boot firmware stored in a firmware memory. A request instruction is sent to an embedded controller, so that the embedded controller collects sensing data. The sensing data is received from the embedded controller. An artificial intelligence module is executed to analyze the sensing data to obtain best parameter setting data under a current operating mode of the electronic apparatus. The artificial intelligence module is stored in the firmware memory, and the best parameter setting data is applied to a parameter storage area.

### CROSS-REFERENCE TO RELATED APPLICATION

This application claims the priority benefit of U.S. provisional application Ser. No. 63/671,768, filed on Jul. 16, 2024. The entirety of the above-mentioned patent application is hereby incorporated by reference herein and made a part of this specification.

### BACKGROUND

### Technical Field

The disclosure relates to a mechanism for controlling an electronic apparatus, and more particularly, to an electronic apparatus and a performance control method thereof.

### Description of Related Art

A current method of calculating system performance requires an additional artificial intelligence (AI) chip to be disposed for calculation. A current approach is to connect the AI chip to an embedded controller in the electronic apparatus, and the embedded controller provides system environment information to the AI chip to calculate recommended settings.

However, in addition to a cost of disposing the additional AI chip, the current approach also has issues with communication delay and increased power consumption. Specifically, the AI chip is connected to the embedded controller through a connection line (e.g., an I2C (inter-integrated circuit) bus). Data from the AI chip is first transmitted to the embedded controller through the I2C bus, and then the embedded controller triggers an event to transmit the data to a basic input/output system (BIOS). Accordingly, a transmission method of the data has the issue with the communication delay and thus may not be updated in real time. In addition, each of performance adjustments requires waking up the AI chip, which will increase power consumption additionally during use and then affect battery life.

### SUMMARY

The disclosure provides an electronic apparatus and a performance control method thereof, which may monitor sensing data of the electronic apparatus in real time and quickly obtain best parameter setting data.

A performance control method of an electronic apparatus in the disclosure executes the following steps through boot firmware stored in a firmware memory, including the following. A request instruction is sent to an embedded controller, so that the embedded controller collects sensing data. The sensing data is received from the embedded controller. An artificial intelligence module is executed to analyze the sensing data to obtain best parameter setting data under a current operating mode of the electronic apparatus. The artificial intelligence module is stored in the firmware memory. The best parameter setting data is applied to a parameter storage area.

In an embodiment of the disclosure, before executing the artificial intelligence module to analyze the sensing data, the method further includes executing the following step through the boot firmware. The current operating mode of the electronic apparatus is obtained from an application program.

In an embodiment of the disclosure, the performance control method further includes executing the following step through the boot firmware. In response to receiving an input instruction from an application program, the request instruction is sent to the embedded controller.

In an embodiment of the disclosure, the performance control method further includes executing the following step through the boot firmware. A power limit range corresponding to the current operating mode is obtained, so that the artificial intelligence module obtains the best parameter setting data based on the power limit range.

In an embodiment of the disclosure, the performance control method further includes executing the following step through the boot firmware. The current operating mode of the electronic apparatus is obtained based on a universally unique identifier (UUID) sent by an operating system.

In an embodiment of the disclosure, the electronic apparatus includes a system processor and a graphics processor. The sensing data includes first load of the system processor and second load of the graphics processor. The step of executing the artificial intelligence module to analyze the sensing data to obtain the best parameter setting data under the current operating mode of the electronic apparatus including the following. In response to the first load being greater than a first preset value and the second load being less than a second preset value, the sensing data is analyzed by the artificial intelligence module to obtain a first value for increasing a power limit of the system processor. The best parameter setting data includes the first value. In response to the first load being less than a third preset value and the second load being greater than a fourth preset value, the sensing data is analyzed by the artificial intelligence module to obtain a second value for increasing total graphics power (TGP) of the graphics processor. The best parameter setting data includes the second value, and the third preset value is less than the fourth preset value. In response to the first load being less than a fifth preset value and greater than a sixth preset value, and the second load being less than the second preset value, the sensing data is analyzed by the artificial intelligence module to obtain a third value for reducing the power limit of the system processor. The best parameter setting data includes the third value.

In an embodiment of the disclosure, the electronic apparatus includes a battery. The sensing data includes current remaining power of the battery. The step of executing the artificial intelligence module to analyze the sensing data to obtain the best parameter setting data under the current operating mode of the electronic apparatus includes the following. In response to the remaining power being less than preset power, the sensing data is analyzed by the artificial intelligence module to obtain a fourth value for limiting thermal design power of the electronic apparatus. The best parameter setting data includes the fourth value.

In an embodiment of the disclosure, the current operating mode is one of multiple modes in the following, and the modes includes a first mode configured to maximize performance, a second mode configured to strike a balance between the performance and power consumption, and a third mode configured to minimize fan noise and the power consumption.

An electronic apparatus in the disclosure, including an embedded controller, a firmware memory including boot firmware and an artificial intelligence module, and a system processor coupled to the firmware memory and the embedded controller, and configured to execute the boot firmware to send a request instruction to the embedded controller, so that the embedded controller collects sensing data, receive the sensing data from the embedded controller, execute the artificial intelligence module to analyze the sensing data to obtain best parameter setting data under a current operating mode of the electronic apparatus, and apply the best parameter setting data to a parameter storage area.

Based on the above, in the disclosure, the artificial intelligence module is built in the firmware memory to reduce communication delay. In addition, since there is no need to wake up an AI chip additionally, it may not only reduce the power consumption but also improve execution efficiency. In addition, the best parameter setting data may be automatically adjusted according to the power limit ranges of different electronic apparatus.

### BRIEF DESCRIPTION OF THE DRAWINGS

FIG. 1 is a block diagram of an electronic apparatus according to an embodiment of the disclosure.

FIG. 2 is a flow chart of a performance control method of an electronic apparatus according to an embodiment of the disclosure.

FIG. 3 is a block diagram of an electronic apparatus according to an embodiment of the disclosure.

FIG. 4 is a flow chart of a performance control method of an electronic apparatus according to an embodiment of the disclosure.

### DETAILED DESCRIPTION OF DISCLOSED EMBODIMENTS

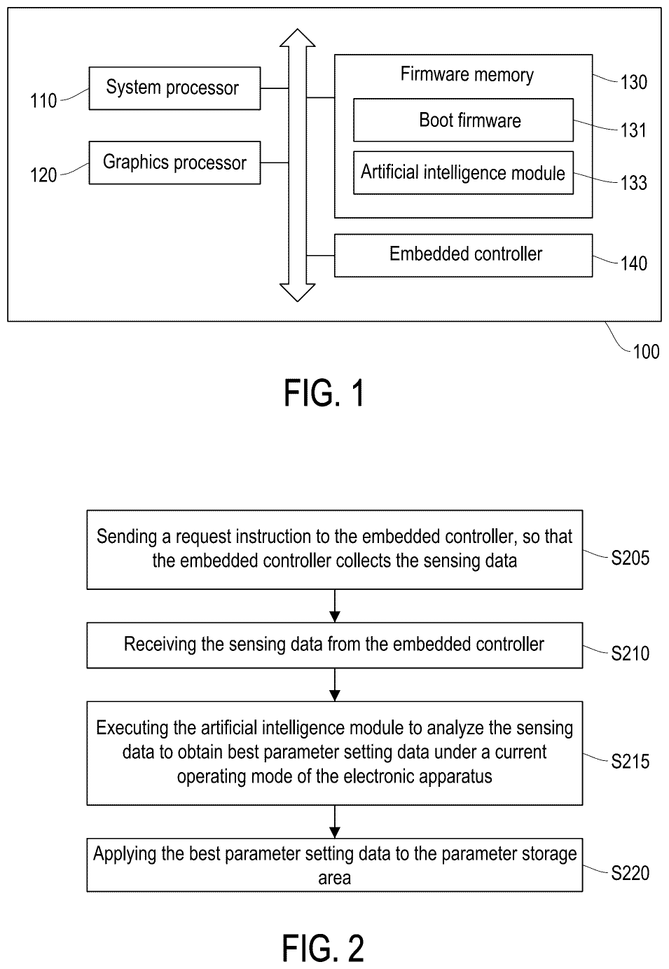

FIG. 1 is a block diagram of an electronic apparatus according to an embodiment of the disclosure. Referring to FIG. 1, an electronic apparatus 100 includes a system processor 110, a graphics processor 120, a firmware memory 130, and an embedded controller 140. The system processor 110 is coupled to the graphics processor 120, the firmware memory 130, and the embedded controller 140. The firmware memory 130 includes boot firmware 131 and an artificial intelligence module 133.

The system processor 110 is, for example, a central processing unit (CPU). The system processor 110 is a core computing unit of the electronic apparatus 100 and is used to process signals and perform calculations.

The graphics processor 120 is an element that connects the system processor 110 and a display (not shown). The graphics processor 120 is used to help the system processor 110 to calculate image information, and convert content to be displayed and provide the content to the display to control an image displayed by the display.

The firmware memory 130 is, for example, a read-only memory (ROM) or a flash memory. The boot firmware 131 is used to execute hardware initialization and test system hardware members during a boot process, and load a boot loader or an operating system. The boot firmware 131 is, for example, a basic input/output system (BIOS), an extensible firmware interface (EFI) BIOS, or a unified extensible firmware interface (UEFI) BIOS.

The artificial intelligence module 133 is a model obtained through machine learning training, which is used to analyze sensing data to obtain optimized parameter data. For example, the artificial intelligence module 133 may determine whether to increase or decrease a power limit according to load ratios of both the system processor 110 and the graphics processor 120 through a decision tree. In addition, the artificial intelligence module 133 may further predict a best power allocation strategy according to historical data through a regression analysis.

The embedded controller 140 is coupled to multiple sensors to obtain the sensing data. Through the embedded controller 140, load, power consumption, and temperature of each of the system processor 110 and the graphics processor 120 may be obtained, and the sensing data such as remaining power of a battery may be obtained.

When the electronic apparatus 100 is powered on, the system processor 110 may read the boot firmware 131 from the firmware memory 130 to execute a performance control method in the following.

FIG. 2 is a flow chart of a performance control method of an electronic apparatus according to an embodiment of the disclosure. Referring to FIG. 2, in step S205, the boot firmware 131 sends a request instruction to the embedded controller 140, so that the embedded controller 140 collects the sensing data. Next, in step S210, the boot firmware 131 receives the sensing data from the embedded controller 140. Then, in step S215, the boot firmware 131 executes the artificial intelligence module 133 to analyze the sensing data to obtain best parameter setting data under a current operating mode of the electronic apparatus 100.

In an embodiment, the boot firmware 131 may query the operating system through DSM

(device specific method) or Windows management instrumentation (WMI) to obtain the current operating mode of the electronic apparatus 100 based on a universally unique identifier (UUID) sent by the operating system. For example, the UUID is “381b4222-f694-41f0-9685-ff5bb260-df2e”, which indicates that the current operating mode is a balance mode. The UUID is “8c5e7fda-e8bf-4a96-9a85-a6e23a8c635c”, which indicates that the current operating mode is a performance mode. The UUID is “a1841308-3541-4fab-bc81-f71556f20b4a”, which indicates that the current operating mode is a quiet mode.

After knowing the current operating mode of the electronic apparatus 100, the boot firmware 131 may obtain a power limit range corresponding to the current operating mode from a corresponding data storage area, so that the artificial intelligence module 133 may obtain the best parameter setting data based on the power limit range. In an embodiment, the current operating mode is one of a first mode, a second mode, and a third mode. For example, the first mode is the performance mode for maximizing performance, the second mode is the balance mode for striking a balance between the performance and power consumption, and the third mode is the quiet mode for minimizing fan noise and the power consumption. Each of the first mode, the second mode, and the third mode has the corresponding power limit range. The power limit range is recorded in the data storage area in the firmware memory 130, for example.

In an embodiment, in the power limit range, minimum and maximum values that may be set for both a power limit level 1 (PL1) and a power limit level 2 (PL2) of the system processor (e.g., CPU) 110 under the corresponding modes are recorded, and minimum and maximum values that may be set for each of configurable total graphic power (cTGP) and a platform power allocation budget (PPAB) under the corresponding modes are further recorded.

The PL1 represents the stable power limit of the system processor 110 under long-term operation. The PL2 represents the maximum power limit allowed for a short period of time when the system processor 110 has an instantaneous high load demand. The cTGP represents an upper limit of total power that the graphics processor 120 may use. The PPAB is a dynamic power allocation mechanism within a budget which can dynamically allocate the power of the entire system to the system processor 110 and the graphics processor 120 according to actual requirements. The PPAB includes two parameters. One parameter of “PpabCpuToGpu” represents the power that the system processor 110 may provide to the graphics processor 120, and the other parameter of “PpabGpuToCpu” represents the power that the graphics processor 120 may release to the system processor 110.

Table 1 below lists an example of the power limit range corresponding to the performance mode (the first mode) for maximizing the performance. However, this is only an example, and is not limited thereto.

TABLE 1

| | Minimum value | Maximum value |
|---|---|---|
| PL1 | 30 | 90 |
| PL2 | 119 | 119 |
| cTGP | 0 | 15 |
| PpabCpuToGpu | 10 | 25 |
| PpabGpuToCpu | 0 | 0 |

The artificial intelligence module 133 may monitor the load, temperature, and power consumption of each of the system processor 110 and the graphics processor 120 in real time, and quickly calculate the best parameter setting data under the current operating mode through the decision tree and/or a regression analysis algorithm. The best parameter setting data are best setting values of parameters such as PL1, PL2, TGP, and PPAB.

The artificial intelligence module 133 calculates the best parameter setting data within the power limit range corresponding to the current operating mode through the current load, temperature, and power consumption of each of the system processor 110 and the graphics processor 120 provided by the boot firmware 131 supplemented by data of both a single-core stress test (only testing the system processor 110 or the graphics processor 120) and a dual-core stress test (testing both the system processor 110 and the graphics processor 120) in a burn-in test adjusted by the Turbo time parameter (Tau) of the system processor 110.

For example, the sensing data includes first load of the system processor 110 and second load of the graphics processor 120. In response to the first load being greater than a first preset value and the second load being less than a second preset value, the artificial intelligence module 133 analyzes the sensing data to obtain a first value for increasing the power limit of the system processor 110. Here, the best parameter setting data includes the first value. For example, if the first load of the system processor 110 is greater than 70%, and the second load of the graphics processor 120 is less than 15%, through the analysis by the artificial intelligence module 133, a value by which PL1 or PL2 of the system processor 110 may be increased may be obtained. In addition, it may be further set that if the first load of the system processor 110 is greater than 90%, and the second load of the graphics processor 120 is less than 15%, through the analysis by the artificial intelligence module 133, a maximum value by which PL1 or PL2 of the system processor 110 may be increased may be obtained. If the first load of the system processor 110 is less than 90% and greater than 70%, and the second load of the graphics processor 120 is less than 15%, through the analysis by the artificial intelligence module 133, a value (less than the maximum value) by which PL1 or PL2 of the system processor 110 may be increased may be obtained.

In addition, in response to the first load being less than a third preset value and the second load being greater than a fourth preset value, the artificial intelligence module 133 analyzes the sensing data to obtain a second value for increasing total graphics power (TGP) of the graphics processor 120. The best parameter setting data includes the second value, and the third preset value is less than the fourth preset value. For example, if the first load of the system processor 110 is less than 50%, and the second load of the graphics processor 120 is greater than 80%, through the analysis by the artificial intelligence module 133, a value by which the total graphics power (TGP) of the graphics processor 120 may be increased may be obtained.

In addition, in response to the first load being less than a fifth preset value and greater than a sixth preset value, and the second load being less than the second preset value, the artificial intelligence module 133 analyzes the sensing data to obtain a third value for reducing the power limit of the system processor 110. The best parameter setting data includes the third value. For example, if the first load of the system processor 110 is less than 50% and greater than 20%, and the second load of the graphics processor 120 is less than 15%, through analysis by the artificial intelligence module 133, a value by which PL1 or PL2 of the system processor 110 may be reduced may be obtained.

For example, the sensing data may further include the current remaining power of the battery. In response to the remaining power being less than preset power, the artificial intelligence module 133 analyzes the sensing data to obtain a fourth value for limiting thermal design power (TDP) of the electronic apparatus 100. For example, if the remaining power of the battery is less than 20%, the maximum thermal design power under the current operating mode is limited to extend battery life.

In an embodiment, the boot firmware 131 may be further set to determine whether the sensing data exceeds a preset threshold value after receiving the sensing data from the embedded controller 140, and execute the artificial intelligence module 133 to analyze the sensing data only when the sensing data exceeds the preset threshold value. For example, it is determined whether the temperature of the system processor 110 exceeds a preset temperature. Alternatively, it is determined whether the power consumption of the system processor 110 exceeds preset power consumption.

Afterwards, the boot firmware 131 applies the best parameter setting data to a parameter storage area. In an embodiment, the parameter storage area is, for example, a complementary metal-oxide-semiconductor (CMOS) disposed in the firmware memory 130. The parameter storage area is used to store a setting value of the boot firmware 131. After obtaining the best parameter setting data by using the artificial intelligence module 133, the boot firmware 131 may directly apply the best parameter setting data to a corresponding position in the parameter storage area.

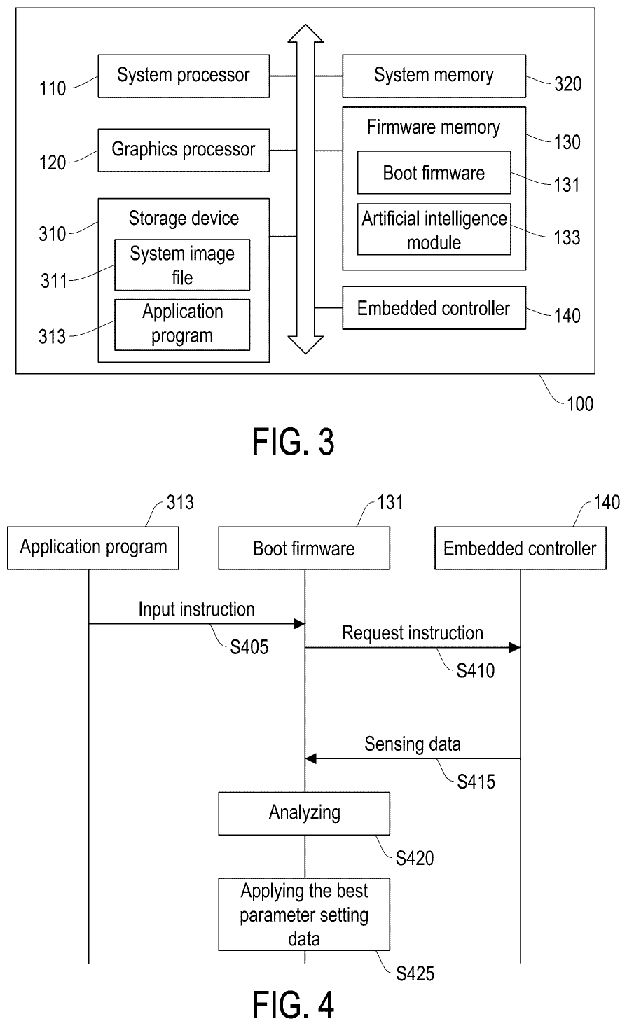

FIG. 3 is a block diagram of an electronic apparatus according to an embodiment of the disclosure. In this embodiment, the electronic apparatus 100 further includes a storage device 310 and a system memory 320. The storage device 310 includes a system image file 311 of the operating system and an application program 313.

The storage device 310 is, for example, a non-volatile storage unit such as a solid state disk (SDD), a hard disk drive (HDD), or a flash memory. During a boot phase, the system processor 110 reads the system image file 311 of the operating system and loads the system image file 311 into the system memory 320 for execution.

The system memory 320 is, for example, a random access memory (RAM), which is a main memory that directly exchanges data with the system processor 110. The system memory 320 is used to load various programs and data for direct execution and use by the system processor 110.

When executing the operating system, the system processor 110 may further execute the application program 313. In an embodiment, the application program 313 provides a method of switching the modes. For example, options are provided in an interface of the application program 313 for a user to check, or shortcut keys are provided for the user to switch the modes. In addition, sub-modes may be further set under the performance mode and the balance mode. The sub-mode may be switched from the performance mode or the balance mode by the application program 313. Each of the sub-modes also has the corresponding power limit range.

In an embodiment, the boot firmware 131 may be set to send the request instruction to the embedded controller 140 in response to receiving an input instruction from the application program 313. In other embodiments, the boot firmware 131 may also be set to send the request instruction to the embedded controller 140 at specified intervals. In an embodiment, the boot firmware 131 may obtain the current operating mode of the electronic apparatus 100 from the application program 313.

FIG. 4 is a flow chart of a performance control method of an electronic apparatus according to an embodiment of the disclosure. FIG. 4 shows an application example based on FIG. 2. Referring to FIG. 4, in step S405, the input instruction is sent to the boot firmware 131 by the application program 313. In an embodiment, the application program 313 provides the interface or the shortcut keys to switch the current operating mode. After determining the current operating mode, the application program 313 sends the input instruction to the boot firmware 131. Accordingly, the boot firmware 131 may know the current operating mode based on the input instruction.

In step S410, after receiving the input instruction, the boot firmware 131 sends the request instruction to the embedded controller 140, so that the embedded controller 140 collects the sensing data.

Next, in step S415, the embedded controller 140 sends the collected sensing data to the boot firmware 131. In step S420, the boot firmware 131 executes the artificial intelligence module 133 to analyze the sensing data to obtain the best parameter setting data under the current operating mode of the electronic apparatus 100. Afterwards, in step S425, the boot firmware 131 directly applies the best parameter setting data to the parameter storage area.

Based on the above, in the disclosure, the artificial intelligence module is built in the firmware memory to reduce communication delay. In addition, since there is no need to wake up an AI chip additionally, it may not only reduce the power consumption but also improve execution efficiency. In addition, the best parameter setting data may be automatically adjusted according to the power limit ranges of different electronic apparatus. Furthermore, after obtaining the best parameter setting data through the built-in artificial intelligence module, the boot firmware may directly apply the best parameter setting data without waiting for a response of the AI chip, solving an issue of the communication delay caused by original use of the AI chip and providing more immediate responses.

What is claimed is:

1. A performance control method of an electronic apparatus, executing following steps through boot firmware stored in a firmware memory, comprising:
sending a request instruction to an embedded controller, so that the embedded controller collects sensing data;
receiving the sensing data from the embedded controller;
executing an artificial intelligence module to analyze the sensing data to obtain best parameter setting data under a current operating mode of the electronic apparatus, wherein the artificial intelligence module is stored in the firmware memory; and
applying the best parameter setting data to a parameter storage area.

2. The performance control method according to claim 1, wherein before executing the artificial intelligence module to analyze the sensing data, the method further comprises executing following step through the boot firmware:
obtaining the current operating mode of the electronic apparatus from an application program.

3. The performance control method according to claim 1, further comprising executing following step through the boot firmware:
in response to receiving an input instruction from an application program, sending the request instruction to the embedded controller.

4. The performance control method according to claim 1, further comprising executing following step through the boot firmware:
obtaining a power limit range corresponding to the current operating mode, so that the artificial intelligence module obtains the best parameter setting data based on the power limit range.

5. The performance control method according to claim 1, further comprising executing following step through the boot firmware:
obtaining the current operating mode of the electronic apparatus based on a universally unique identifier sent by an operating system.

6. The performance control method according to claim 1, wherein the electronic apparatus comprises a system processor and a graphics processor, the sensing data comprises first load of the system processor and second load of the graphics processor, and the step of executing the artificial intelligence module to analyze the sensing data to obtain the best parameter setting data under the current operating mode of the electronic apparatus comprises:
in response to the first load being greater than a first preset value and the second load being less than a second preset value, analyzing, by the artificial intelligence module, the sensing data to obtain a first value for increasing a power limit of the system processor, wherein the best parameter setting data comprises the first value;
in response to the first load being less than a third preset value and the second load being greater than a fourth preset value, analyzing, by the artificial intelligence module, the sensing data to obtain a second value for increasing total graphics power of the graphics processor, wherein the best parameter setting data comprises the second value, and the third preset value is less than the fourth preset value;
in response to the first load being less than a fifth preset value and greater than a sixth preset value, and the second load being less than the second preset value, analyzing, by the artificial intelligence module, the sensing data to obtain a third value for reducing the power limit of the system processor, wherein the best parameter setting data comprises the third value.

7. The performance control method according to claim 1, wherein the electronic apparatus comprises a battery, the sensing data comprises current remaining power of the battery, and the step of executing the artificial intelligence module to analyze the sensing data to obtain the best parameter setting data under the current operating mode of the electronic apparatus comprises:
in response to the remaining power being less than preset power, analyzing, by the artificial intelligence module, the sensing data to obtain a fourth value for limiting thermal design power of the electronic apparatus, wherein the best parameter setting data comprises the fourth value.

8. The performance control method according to claim 1, wherein the current operating mode is one of a plurality of modes in following, and the modes comprise:
a first mode configured to maximize performance;
a second mode configured to strike a balance between the performance and power consumption;
a third mode configured to minimize fan noise and the power consumption.

9. An electronic apparatus, comprising:
an embedded controller;
a firmware memory comprising boot firmware and an artificial intelligence module;
a system processor coupled to the firmware memory and the embedded controller, and configured to execute the boot firmware to:
send a request instruction to the embedded controller, so that the embedded controller collects sensing data;
receive the sensing data from the embedded controller;
execute the artificial intelligence module to analyze the sensing data to obtain best parameter setting data under a current operating mode of the electronic apparatus; and
apply the best parameter setting data to a parameter storage area.

10. The electronic apparatus according to claim 9, wherein the system processor is configured to execute the boot firmware to:
before executing the artificial intelligence module to analyze the sensing data, obtain the current operating mode of the electronic apparatus from an application program.

11. The electronic apparatus according to claim 9, wherein the system processor is configured to execute the boot firmware to:
in response to receiving an input instruction from an application program, send the request instruction to the embedded controller.

12. The electronic apparatus according to claim 9, wherein the system processor is configured to execute the boot firmware to:
obtain a power limit range corresponding to the current operating mode, so that the artificial intelligence module obtains the best parameter setting data based on the power limit range.

13. The electronic apparatus according to claim 9, wherein the system processor is configured to execute the boot firmware to:
obtain the current operating mode of the electronic apparatus based on a universally unique identifier sent by an operating system.

14. The electronic apparatus according to claim 9, further comprising a graphics processor, wherein the sensing data comprises first load of the system processor and second load of the graphics processor, and the system processor is configured to execute the boot firmware to:
in response to the first load being greater than a first preset value and the second load being less than a second preset value, analyze, by the artificial intelligence module, the sensing data to obtain a first value for increasing a power limit of the system processor, wherein the best parameter setting data comprises the first value;
in response to the first load being less than a third preset value and the second load being greater than a fourth preset value, analyze, by the artificial intelligence module, the sensing data to obtain a second value for increasing total graphics power of the graphics processor, wherein the best parameter setting data comprises the second value, and the third preset value is less than the fourth preset value;
in response to the first load being less than a fifth preset value and greater than a sixth preset value, and the second load being less than the second preset value, analyze, by the artificial intelligence module, the sensing data to obtain a third value for reducing the power limit of the system processor, wherein the best parameter setting data comprises the third value.

15. The electronic apparatus according to claim 9, further comprising a battery, wherein the sensing data comprises current remaining power of the battery, and the system processor is configured to execute the boot firmware to:
in response to the remaining power being less than preset power, analyze, by the artificial intelligence module, the sensing data to obtain a fourth value for limiting thermal design power of the electronic apparatus, wherein the best parameter setting data comprises the fourth value.

16. The electronic apparatus according to claim 9, wherein the current operating mode is one of a plurality of modes in following, and the modes comprise:
a first mode configured to maximize performance;
a second mode configured to strike a balance between the performance and power consumption;
a third mode configured to minimize fan noise and the power consumption.
